(19) United States
(12) Patent Application Publication
(10) Pub. No.: US 2024/0407026 A1
(43) Pub. Date: Dec. 5, 2024

(54) CONNECTION METHODS AND ELECTRONIC DEVICE SYSTEM

(71) Applicant: Lenovo (Beijing) Limited, Beijing (CN)

(72) Inventors: Changfu LI, Beijing (CN); Song YE, Beijing (CN)

(21) Appl. No.: 18/678,844

(22) Filed: May 30, 2024

(30) Foreign Application Priority Data
May 31, 2023 (CN) 202310637638.5

(51) Int. Cl. H04W 76/15; H04W 40/24

(52) U.S. Cl. CPC H04W 76/15; H04W 40/24

(57) ABSTRACT

A connection method includes sending a coding downlink signal to a second electronic device, the coding downlink signal carrying an identifier of a first communication module of the first electronic device; obtaining a request from the second electronic device to establish a first communication connection based on the identifier; determining that a communication connection status of the first communication module of the first electronic device does not meet a preset condition; and adjusting the communication connection status to establish the first communication connection with the second electronic device based on the first communication module.

### CROSS-REFERENCE TO RELATED APPLICATION

This application claims priority to Chinese Patent Application No. 202310637638.5, filed on May 31, 2023, the entire content of which is incorporated herein by reference.

### TECHNICAL FIELD

The present disclosure relates to the technical field of communications and, in particular, to connection methods, apparatus, and electronic device system.

### BACKGROUND

In Bluetooth pairing connection, the electronic pen triggers its Bluetooth broadcast of the electronic pen by pressing the Bluetooth button. A user manually turns on Bluetooth on the display device, searches for the Bluetooth device name of the electronic pen, and manually clicks to perform Bluetooth pairing, to realize the Bluetooth connection function. The electronic pen Bluetooth solution is cumbersome and requires users to search for Bluetooth devices one-by-one for connecting. When the electronic pen controls multiple devices, it is challenging to automatically adjust the connection status of the device, resulting in poor user experience.

### SUMMARY

One aspect of the present disclosure provides a connection method, applied to a first electronic device. The connection method includes sending a coding downlink signal to a second electronic device, where the coding downlink signal carries an identifier of a first communication module of the first electronic device. The connection method includes obtaining a request from the second electronic device to establish a first communication connection based on the identifier. The connection method includes determining that a communication connection status of the first communication module of the first electronic device does not meet a preset condition. The connection method also includes adjusting the communication connection status to establish the first communication connection with the second electronic device based on the first communication module.

Another aspect of the present disclosure provides a connection method, applied to a second electronic device. The connection method includes obtaining a coding downlink signal sent by the first electronic device, where the coding downlink signal carries the identifier of the first communication module of the first electronic device. The connection method includes sending a request to establish the first communication connection based on the identifier to the first electronic device. The connection method also includes obtaining a broadcast message sent by the first electronic device to establish the first communication connection with the first communication module of the first electronic device.

Another aspect of the present disclosure provides an electronic device system. The electronic equipment system includes the first electronic device. The first electronic device includes at least one processor and a memory containing program instructions that, when being executed, cause the at least one processor to send the coding downlink signal to the second electronic device, the coding downlink signal carrying the identifier of the first communication module of the first electronic device; obtain the request from the second electronic device to establish the first communication connection based on the identifier; determine that the communication connection status of the first communication module of the first electronic device does not meet the preset condition; and adjust the communication connection status to establish the first communication connection with the second electronic device based on the first communication module. The electronic equipment system further includes at least one third electronic device, establishing a second communication connection with the first communication module.

### BRIEF DESCRIPTION OF THE DRAWINGS

FIG. 1 illustrates a schematic flowchart of implementing a connection method according to various embodiments of the present disclosure.

FIG. 2A illustrates a schematic flowchart of implementing a method for adjusting the quantity of second communication connections according to various embodiments of the present disclosure.

FIG. 2B illustrates a schematic diagram of Bluetooth MAC address data transmission in the downlink coding signal of an electronic pen according to various embodiments of the present disclosure.

FIG. 2C illustrates a schematic diagram of a coding uplink signal of a first command according to various embodiments of the present disclosure.

FIG. 3A illustrates a schematic flowchart of implementing a connection method according to various embodiments of the present disclosure.

FIG. 3B illustrates a schematic network architectural diagram of an electronic device system according to various embodiments of the present disclosure.

FIG. 4 illustrates a schematic flowchart of a Bluetooth connection method between a display device and an electronic pen according to various embodiments of the present disclosure.

FIG. 5A illustrates a schematic structural diagram of a connection apparatus according to various embodiments of the present disclosure.

FIG. 5B illustrates a schematic structural diagram of a connection apparatus according to various embodiments of the present disclosure.

FIG. 6 illustrates a hardware entity diagram of an electronic device according to various embodiments of the present disclosure.

### DETAILED DESCRIPTION OF THE EMBODIMENTS

To better describe the purpose, technical solutions, and advantages of embodiments of the present disclosure, specific technical solutions of embodiments of the present disclosure will be further described in detail below in conjunction with the drawings in embodiments of the present disclosure. The following examples are used to illustrate the present disclosure but are not intended to limit the scope of the present disclosure.

In the description, reference is made to “some embodiments” which describe a subset of all possible embodiments, but it can be interpreted that “some embodiments” can be the same subset or a different subset of all possible embodiments, and can be combined with each other without conflict.

In the following description, the terms “first\second\third” are only used to distinguish similar objects and do not represent a specific ordering of objects. It can be interpreted that where “first\second\third” are permitted, the specific order or sequence can be interchanged so that embodiments of the present disclosure described herein can be implemented in an order other than that illustrated or described herein.

Unless otherwise defined, all technical and scientific terms used herein have the same meaning as commonly understood by persons of ordinary skill in the art to which this application belongs. The terms used herein are only for the purpose of describing embodiments of the present disclosure and are not intended to limit the present disclosure.

Before describing embodiments of the present disclosure in detail, the nouns and terms involved in embodiments of the present disclosure are explained. The nouns and terms involved in embodiments of the present disclosure are applicable to the following explanations.

Bluetooth technology is an open global specification for wireless data and voice communications. Based on low-cost and short-range wireless connections, it is a special short-range wireless technology connection that establishes a communication environment for landline and mobile devices.

Wireless Fidelity (WiFi) can be used to convert wired network signals into wireless signals for reception by computers, mobile phones, tablets, etc., which support the WiFi technology.

Infrared Data Association (IrDA) connection is an infrared wireless transmission protocol and a wireless transmission based on the protocol.

Near Field Communication (NFC) is an improved data transmission based on radio frequency identification (RFID). Through radio waves, NFC can be used to transmit data between devices that are several centimeters apart from each other.

Zigbee technology is a wireless communication technology applied at short distance and low speed. It is used for data transmission between various electronic devices with short distance, low power consumption, and low transmission rate, as well as applications of transmitting typical periodic data, intermittent data, and low response time data.

Ultra Wide Band (UWB) technology is a wireless carrier communication technology that uses nanosecond-level non-sinusoidal narrow pulses to transmit data. Thus, it occupies a wide spectrum range.

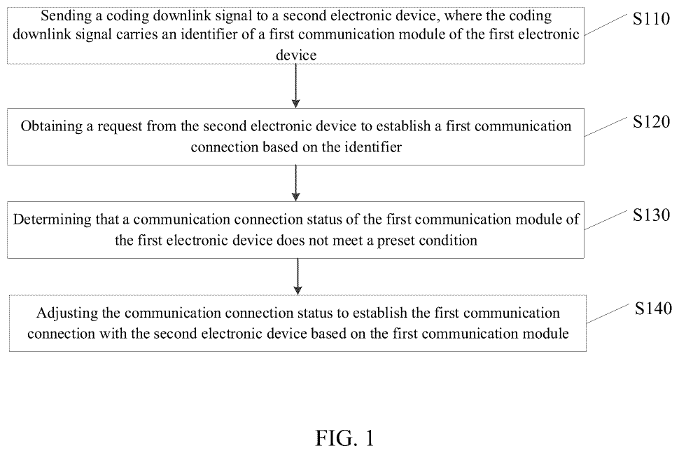

Embodiments of the present disclosure provide a connection method, which is applied to a first electronic device. As shown in FIG. 1, the method includes following steps.

Step S110: Sending a coding downlink signal to a second electronic device, wherein the coding downlink signal carries an identifier of a first communication module of the first electronic device.

Here, the coding downlink signal is a coding signal sent by a first electronic device to a second electronic device, and can be used to establish wireless data communication with the second electronic device.

A first communication module of the first electronic device can be a module that establishes a wireless communication connection with other electronic devices. For example, the wireless communication connection may be a Bluetooth connection, a WiFi connection, an IrDA connection, an NFC connection, a ZigBee connection, or a UWB connection, etc.

An identifier of the first communication module of the first electronic device can be a unique identification of the first electronic device for implementing wireless communication. For example, the identifier can be a Media Access Control Address (MAC address) of the first electronic device, which is also known as a physical address.

During the implementation process, the coding downlink signal carries the identifier of the first communication module of the first electronic device, that is, the identifier can be sent to the second electronic device.

During the implementation process, when the first electronic device confirms receiving the coding uplink signal sent by the second electronic device, it can send the coding downlink signal to the second electronic device to perform data communication with the second electronic device. Here, the coding uplink signal sent by the second electronic device can include a second command to establish communication with the first electronic device. That is, the uplink coding signal can be used as the timing or synchronization signal for the first electronic device to send the downlink coding signal.

In one embodiment, the first electronic device can be an electronic pen, and the second electronic device can be a display device with a touch screen, such as a personal computer, a tablet computer, a smart phone, etc., The second electronic device can also be an electronic device with touch functions but without display screens, such as handwriting tablets, etc.

Step S120: Obtaining a request from the second electronic device to establish a first communication connection based on the identifier.

During the implementation process, after receiving the identifier of the first electronic device, the second electronic device can first determine whether wireless communication needs to be established with the first electronic device. When it is determined that wireless communication needs to be established with the first electronic device, a request to establish a first communication is sent to the first electronic device. For example, when the second electronic device is a display device and the first electronic device is an electronic pen, the display device receives the MAC address of the electronic pen and determines that wireless communication needs to be established with the electronic pen based on the MAC address, a request to establish wireless communication can be sent to the electronic pen.

Step S130: Determining that a communication connection status of the first communication module of the first electronic device does not meet a preset condition.

Here, since the quantity of devices connected to the first communication module can have a preset condition, that is, there is a maximum quantity of devices connected to the first communication module. The communication connection status can be determined the quantity of connected electronic devices by the first communication module.

During the implementation process, failure to satisfy the preset condition can be due to the fact that the quantity of connected electronic devices by the first communication module has been saturated and no more electronic devices can be connected.

Step S140: Adjusting the communication connection status to establish the first communication connection with the second electronic device based on the first communication module.

Here, adjusting the communication connection status can be adjusting the quantity of electronic devices connected to the first communication module, so that the first communication module can continue to establish the first communication connection with the second electronic device. For example, disconnecting one Bluetooth device from the electronic pen makes the quantity of Bluetooth connections of the electronic pen change from saturated to unsaturated. This can establish a Bluetooth communication connection between the display device and the electronic pen.

In embodiments of the present disclosure, a coding downlink signal is first sent to the second electronic device, where the coding downlink signal carries the identifier of the first communication module of the first electronic device. Then, a request from the second electronic device to establish a first communication connection based on the identifier is obtained. The communication connection status of the first communication module of the first electronic device is determined as failing to meet the preset condition. Finally, the communication connection status is adjusted to establish a first communication connection with the second electronic device based on the first communication module. In this way, when the communication connection status of the first electronic device does not meet the preset condition, the communication connection status can be automatically adjusted to achieve an accurate and convenient first communication connection between the first electronic device and the second electronic device.

In some embodiments, satisfying the preset condition includes determining that a quantity of second communication connections established by the first communication module and a third electronic device being less than a preset threshold.

Here, the third electronic device can be an electronic device that has established a second communication connection with the first communication module. During the implementation process, the quantity of second communication connections established by the first communication module and the third electronic device is less than the preset threshold, that is, the electronic devices establishing communication connections with the first communication module have not reached saturation, and can add first communication connection to the second electronic device.

The above connection method also includes the following steps.

A quantity of second communication connections established by the first communication module and the third electronic device is determined to be less than a preset threshold. A first communication connection of the second electronic device is established based on the first communication module.

In embodiments of the present disclosure, the first electronic device determines that the quantity of second communication connections established by the first communication module and the third electronic device is less than a preset threshold. A first communication connection of the second electronic device is established with the first electronic device based on the first communication module. In this way, when the preset condition is met, the first electronic device and the second electronic device can accurately and conveniently establish the first communication connection.

In some embodiments, the step S130 “determining that a communication connection status of the first communication module of the first electronic device does not meet a preset condition” can be implemented by the following steps.

Step 131: Determining that a quantity of second communication connections established by the first communication module and a third electronic device being greater than or equal to a preset threshold.

If the quantity of second communication connections established by the first communication module and the third electronic device is greater than or equal to the preset threshold, it can be determined that the quantity of connections of the first communication module has been saturated and a new first communication connection cannot be established with the second electronic device.

Step 132: Adjusting the quantity of second communication connections between the first communication module and the third electronic device to meet the preset condition.

During implementation, adjusting the quantity of second communication connections between the first communication module and the third electronic device can be reducing the quantity of second communication connections between the first communication module and the third electronic device. The connection data of the first communication module is adjusted from a saturated state to an unsaturated state, so that the first communication module can establish a new communication connection.

In embodiments of the present disclosure, it is first determined that the quantity of second communication connections established between the first communication module and the third electronic device is greater than or equal to the preset threshold. Then the quantity of second communication connections between the first communication module and the third electronic device is adjusted to meet the preset condition. In this way, by adjusting the quantity of communication connections of the first communication module, the first communication module can establish a new communication connection.

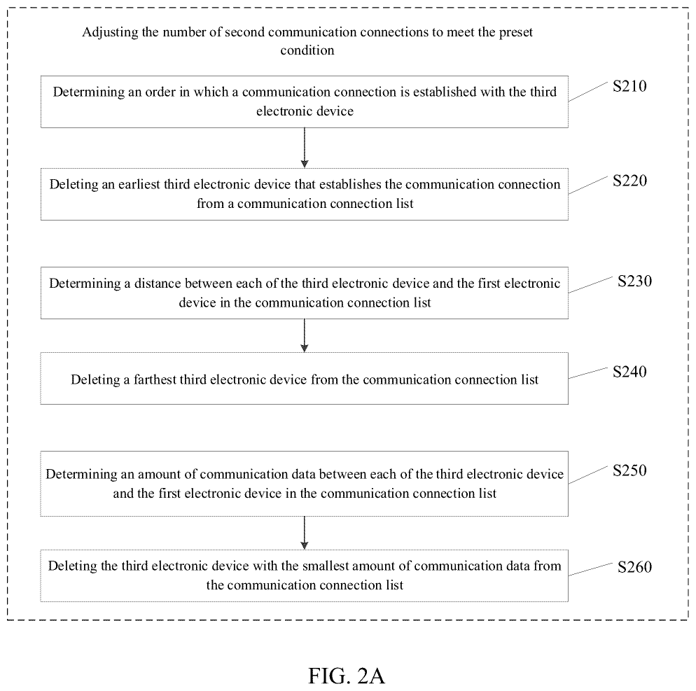

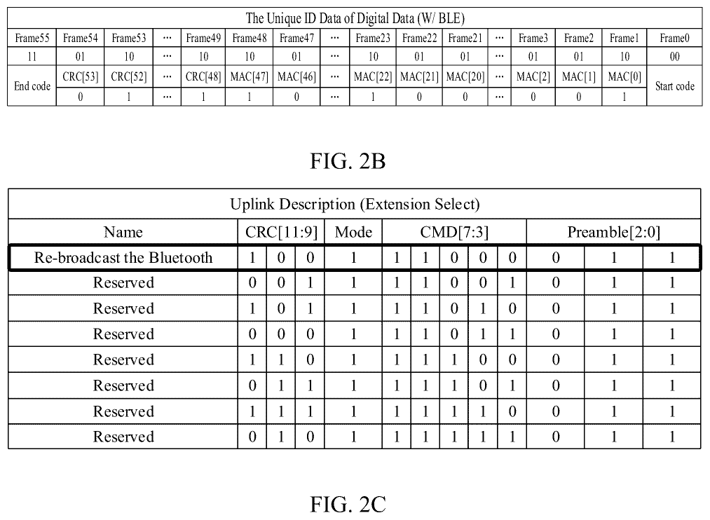

In some embodiments, as shown in FIG. 2A, adjusting the quantity of second communication connections to meet the preset condition includes the following steps.

Step S210: Determining an order in which a communication connection is established with the third electronic device.

Step S220: Deleting an earliest third electronic device that establishes the communication connection from a communication connection list.

Here, the communication connection list can store the identifiers of the electronic device that establishes a connection with the first electronic device. During the implementation process, the order in which the first electronic device and the third electronic device establish communication connections can be determined first. The earliest third electronic device that establishes the communication connection is determined. It is possible that data communication is no longer performed. Thus, the communication connection of the earliest third electronic device is deleted.

Alternatively, step S230: Determining a distance between each of the third electronic device and the first electronic device in the communication connection list. A method of determining the distance can be Bluetooth ranging or UWB ranging.

Step S240: Deleting a farthest third electronic device from the communication connection list.

Here, the farthest third electronic device, the farthest distance in the communication connection list, can be determined first. Since the distance between the farthest third electronic device and the first electronic device is the farthest and the communication effect is the worst, it can be determined that the communication efficiency between the farthest third electronic device and the first electronic device is low. Therefore, the communication connection of the farthest third electronic device is deleted.

Alternatively, step S250: Determining an amount of communication data between each of the third electronic device and the first electronic device in the communication connection list.

Step S260: Deleting the third electronic device with the smallest amount of communication data from the communication connection list.

Here, the third electronic device with the smallest quantity of data in the communication connection list can be determined first. Since the quantity of data between the third electronic device and the first electronic device is the smallest and the data interaction for communication is the least, it can be determined that the third electronic device has low demand for the first electronic device, so the communication connection of the third electronic device is deleted.

In embodiments of the present disclosure, using at least one of the above three methods, the first electronic device can determine a third electronic device that can be deleted, so that the quantity of connections of the first communication module of the first electronic device changes from saturated to unsaturated. A new communication connection can be established.

In some embodiments, the coding downlink signal in each frame includes partial data of the identifier.

The first electronic device can use each frame to encode the part of the data sending the identifier of the downlink signal. For example, when identified as the MAC address of a Bluetooth communication module, the transmission data bits of the MAC address only occupy part of the data bits in the downlink data bits of each frame, such as 2 bits. Combined with the 6-bit Cyclic Redundancy Check (CRC) check, it enhances the accuracy of downlink data transmission. Multiple frames are required to complete the transmission of the complete Bluetooth MAC address.

FIG. 2B is a schematic diagram of Bluetooth MAC address data transmission in the downlink coding signal of an electronic pen provided by embodiments of the present disclosure.

In the Unique ID Data of Digital Data table, Frame0 transmits 00 to represent the start code, which means starting to transmit the MAC address. Frame1 to Frame48 represent the MAC address. Frame49 to Frame54 represent the check code. Frame55 represents the end code.

In embodiments of the present disclosure, the coding downlink signal of each frame includes partial data of the identifier. In this way, it is possible to avoid affecting other functional information of coding downlink signals of the normal first electronic device in each frame, and to completely and effectively send the identifier of the first communication module to the second electronic device.

In some embodiments, the step S120 “Obtaining the request from the second electronic device to establish a first communication connection based on the identifier” can be implemented through the following process.

Receiving a coding uplink signal sent by the second electronic device based on the identifier; And in the event the coding uplink signal comprises a first command, confirming obtaining the request from the second electronic device to establish a first communication connection based on the identifier.

Here, the first command can be a command for instructing the first electronic device to send the communication broadcast. For example, the display device sends a first command to the electronic pen, that is, sends an interrupt instruction to the electronic pen to instruct the electronic pen to perform Bluetooth broadcast again.

FIG. 2C is a schematic diagram of a coding uplink signal of a first command provided by embodiments of the present disclosure. As shown in FIG. 2C, the coding uplink signal includes a first command instructing the electronic pen to re-broadcast the Bluetooth.

In embodiments of the present disclosure, the coding uplink signal sent by the second electronic device to the first electronic device based on the identifier includes a first command, which can be used to request the first electronic device to resend the connection broadcast to the second electronic device based on the request to establish the first communication connection.

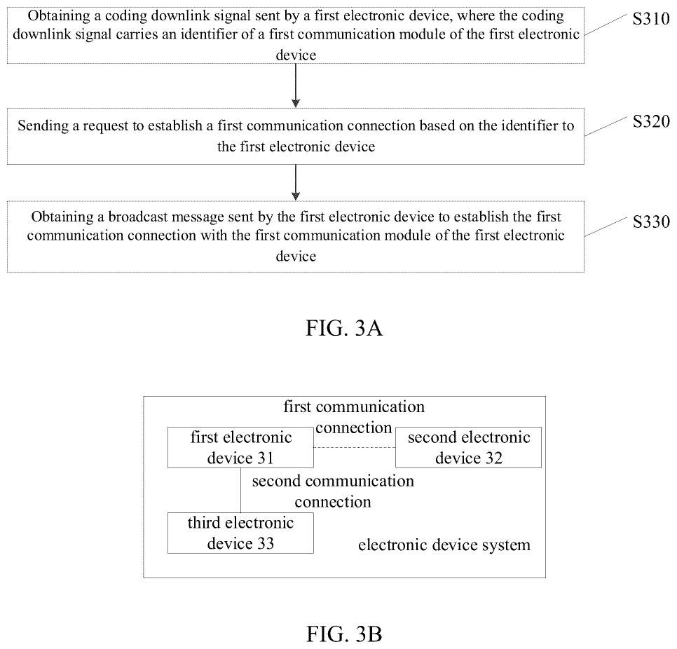

Embodiments of the present disclosure provide a connection method, applied to a second electronic device, as shown in FIG. 3A, including the following steps.

Step S310: Obtaining a coding downlink signal sent by a first electronic device, wherein the coding downlink signal carries an identifier of a first communication module of the first electronic device.

Here, the second electronic device can first send the coding uplink signal to the first electronic device to perform data communication with the first electronic device, and then receive the coding uplink signal carrying the identifier sent by the first electronic device.

During implementation, the second electronic device can determine whether the first communication connection has been established with the first electronic device based on the identifier. When it is determined that the first communication connection is not established with the first electronic device, it is determined based on the communication identifier that the first communication connection is not established with the first electronic device. The communication connection function is turned on. The communication connection with the first electronic device is obtained. The first electronic device establishes a connection instruction for the first communication connection. The connection instruction can be obtained based on user settings. For example, first the display device determines whether to connect to the electronic pen with this Bluetooth MAC address. Then the display device determines whether the Bluetooth connection function is turned on. The display device pops up a Bluetooth pairing/connection window to allow the user to determine whether Bluetooth pairing is required. Finally, Bluetooth pairing instructions determined by the user are obtained.

Step S320: Sending a request to establish a first communication connection based on the identifier to the first electronic device.

The second electronic device can send a coding uplink signal based on the identifier, and the coding uplink signal includes a first command to send a request to establish a first communication connection to the first electronic device. Here, the first command can be a command for instructing the first electronic device to send the communication broadcast. For example, the display device sends a first command to the electronic pen, that is, sends an interrupt instruction to the electronic pen to instruct the electronic pen to perform Bluetooth broadcast again.

Step S330: Obtaining a broadcast message sent by the first electronic device to establish the first communication connection with the first communication module of the first electronic device.

Here, after obtaining the broadcast message, the second electronic device can establish a first communication connection with the first electronic device. For example, after obtaining the Bluetooth broadcast message sent by the electronic pen, the display device can establish a Bluetooth connection with the electronic pen.

In embodiments of the present disclosure, the coding downlink signal sent by the first electronic device is first obtained, where the coding downlink signal carries the identifier of the first communication module of the first electronic device. Then, a request is sent to the first electronic device to establish a first communication connection based on the identifier. Finally, the broadcast message sent by the first electronic device is obtained to establish a first communication connection with the first communication module of the first electronic device. In this way, an accurate and convenient first communication connection between the first electronic device and the second electronic device can be achieved based on the coding downlink signal carrying the identifier sent by the first electronic device.

In some embodiments, the step S310 “Obtaining a coding downlink signal sent by a first electronic device, where the coding downlink signal carries an identifier of a first communication module of the first electronic device” can be implemented through the following process.

Obtaining a multi-frame coding downlink signal sent by the first electronic device, where each frame of the multi-frame coding downlink signal carries a partial identifier data of the first communication module of the first electronic device, and based on a multi-frame of the partial identifier data, the identifier data of the first communication module is obtained.

During the implementation process, after the second electronic device obtains the coding downlink signal sent by the first electronic device, the second electronic device determines that the first communication connection has not been established with the first electronic device based on the identifier. The second electronic device determines the communication connection function is turned on, and obtains a connection instruction to establish the first communication connection with the first electronic device. Based on the connection instruction, step S320, a request is sent to establish a first communication connection based on the communication identifier to the first electronic device.

In embodiments of the present disclosure, the coding downlink signal of each frame includes partial data of the identifier. In this way, it is possible to avoid affecting other functional information of the normal first electronic device coding downlink signals in each frame, and to completely and effectively send the identifier of the first communication module to the second electronic device.

FIG. 3B is a schematic network architectural diagram of an electronic device system according to various embodiments of the present disclosure. As shown in FIG. 3B, the schematic network architectural diagram includes:
A first electronic device 31, sending a coding downlink signal to a second electronic device, wherein the coding downlink signal carries an identifier of a first communication module of the first electronic device;
Obtaining a request from the second electronic device to establish a first communication connection based on the identifier;
Determining that a communication connection status of the first communication module of the first electronic device does not meet a preset condition;
Adjusting the communication connection status to establish the first communication connection with the second electronic device based on the first communication module.

The second electronic device 32 obtains the coding downlink signal sent by the first electronic device, wherein the coding downlink signal carries the identifier of the first communication module of the first electronic device;

Sending a request to establish the first communication connection based on the identifier to the first electronic device;

Obtaining a broadcast message sent by the first electronic device to establish the first communication connection with the first communication module of the first electronic device;
at least one third electronic device, configured to establish a second communication connection with the first communication module.

In embodiments of the present disclosure, the first device in the electronic device system sends a coding downlink signal carrying an identifier to the second electronic device, and the second electronic device sends a request to the first electronic device to establish a first communication connection based on the identifier. The first device determines that the communication connection condition of the first communication module of the first electronic device does not meet the preset condition. The communication connection status is adjusted, a broadcast message is sent, and a first communication connection is established with the second electronic device. In this way, when the communication connection status of the first electronic device does not meet the preset condition, the communication connection status can be automatically adjusted to achieve an accurate and convenient first communication connection between the first electronic device and the second electronic device.

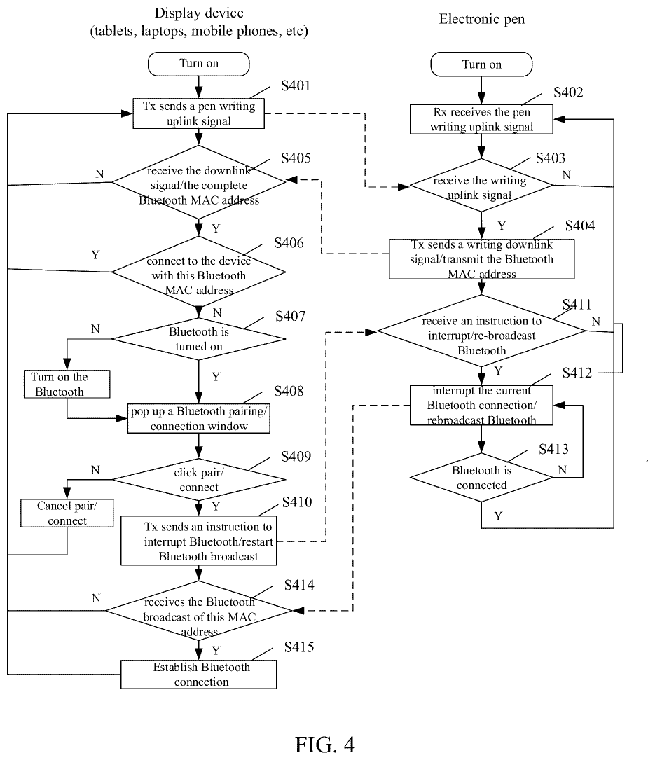

FIG. 4 is a schematic flowchart of a Bluetooth connection method between a display device and an electronic pen according to various embodiments of the present disclosure. As shown in FIG. 4, the schematic diagram includes the following steps.

Step S401: The display device sends a pen writing uplink signal to the electronic pen;

Here, display devices include tablets, laptops, mobile phones, etc.

When the display device (second electronic device) and the electronic pen (first electronic device) do not establish Bluetooth communication, the display device can interact with the electronic pen using the coding uplink signal.

Step S402: The electronic pen receives the pen writing uplink signal sent by the display device;

Here, the pen writing uplink signal can be a coding uplink signal.

During the implementation process, the electronic pen can receive the coding uplink signal sent by the display device.

Step S403: The electronic pen determines whether it receives the pen writing uplink signal;

If the electronic pen determines that the pen writing uplink signal is received, step S404 is executed. If the electronic pen does not receive the pen writing uplink signal, step S402 is executed.

Step S404: The electronic pen sends a writing downlink signal to the display device to transmit the Bluetooth MAC address of the electronic pen;

Here, the writing downlink signal can be a coding downlink signal. During the use of the electronic pen, the pen tip of the electronic pen can emit a coding downlink signal with a fixed voltage. After the display device detects the coding downlink signal, the display device can perform the corresponding handwriting function based on the coding downlink signal or hand drawing function.

The electronic pen uses the downlink data sent by the coding downlink signal, including the electronic pen's pressure sensitivity, keystrokes and other data. In order to avoid affecting the normal writing experience such as fast pen entry, when the downlink data is used to transmit the Bluetooth MAC address of the electronic pen, the transmission data bits of the Bluetooth MAC address only occupy 40% of the downlink data bits of each frame. A small quantity of 2 bits, but not limited to 2 bits, combined with a 6-bit Cyclic Redundancy Check (CRC) check, enhances the accuracy of downlink data transmission. A total of up to 54 frames are needed to complete the transmission of the complete Bluetooth MAC address.

FIG. 2B is a schematic diagram of Bluetooth MAC address data transmission in the downlink coding signal of an electronic pen according to various embodiments of the present disclosure. As shown in FIG. 2B, Frame0 transmits 00 to represent the start code. Frame1 to Frame48 represent the MAC address. Frame49 to Frame54 represent the check code. Frame55 represents the end code.

Step S405: The display device determines whether it has received the complete Bluetooth MAC address based on receiving the pen downlink signal.

During implementation, the display device can determine whether a complete Bluetooth MAC address was received based on the checksum or check code. As shown in FIG. 2B, in The Unique ID Data of Digital Data Table 22, each of the 6 bits of the check code CRC [53:48] of 101001 can be used to check each of the 6 bits of the MAC address. For example, the MAC Addr1 [7:0] corresponding to the first digit of MAC address 01 is 00000001, and the result of the XOR operation on 00000001 is 1, which is consistent with the first 1 in the check code 101001, then the first MAC address passed verification. Here, if all 6-digit MAC addresses pass the verification, it can be determined that the complete Bluetooth MAC address has been received.

Step S406: The display device determines whether to connect to the electronic pen with this Bluetooth MAC address.

When the display device determines that it is connected to the electronic pen with this Bluetooth MAC address, step S401 is executed to interact with the electronic pen for coding signals. When the display device determines that it is not connected to the electronic pen with this Bluetooth MAC address, step S407 is executed.

Step S407: The display device determines whether the Bluetooth connection function is turned on.

When the display device determines that the Bluetooth connection function has been turned on, step S408 is executed; When the display device determines that the Bluetooth connection function is not turned on, Bluetooth is turned on.

Step S408: The display device pops up a Bluetooth pairing/connection window.

Here, the display device can pop up a Bluetooth pairing/connection window and has received the user's instruction to click pairing/connection.

Step S409, clicking Pair/Connect.

The display device determines whether to obtain Bluetooth pairing instructions for pairing/connecting.

When the display device obtains the Bluetooth pairing instruction, step S410 is executed. When the display device does not obtain the Bluetooth pairing instruction, the Bluetooth pairing/connection is cancelled.

Step S410: The display device sends an instruction to interrupt Bluetooth/restart Bluetooth broadcasting to the electronic pen.

Here, the display device can send interrupt Bluetooth information by the coding uplink signal to request the electronic pen to resume Bluetooth broadcasting. That is, the coding uplink signal includes an instruction to request the electronic pen to resume Bluetooth broadcasting.

FIG. 2C is a schematic diagram of a coding uplink signal of a first command provided by embodiments of the present disclosure. As shown in FIG. 2C, the coding uplink signal includes a first command instructing the electronic pen to re-broadcast the Bluetooth.

Step S411: The electronic pen receives an instruction to interrupt/re-broadcast Bluetooth and determines whether to re-broadcast Bluetooth.

When the electronic pen determines to re-broadcast Bluetooth, step S412 is executed. When the electronic pen determines not to re-broadcast Bluetooth, step S402 is executed to interact with the display device through coding signals.

Step S412: The electronic pen interrupts the current Bluetooth connection and performs Bluetooth broadcast again.

After the electronic pen receives the instruction to re-initiate Bluetooth broadcasting, the terminal is currently connected to Bluetooth and re-initiates Bluetooth broadcasting. It determines whether the quantity of Bluetooth connections in the Bluetooth connection list is saturated. When it is determined that the quantity of Bluetooth connections is saturated, one Bluetooth connection can be deleted.

Step S413: The electronic pen determines whether a Bluetooth connection has been established with the display device.

If the electronic pen determines that a Bluetooth connection has been established with the display device, step S402 is executed. If it is determined that a Bluetooth connection has not been established with the display device, step S412 is executed.

Step S414: The display device receives the Bluetooth broadcast sent by the electronic pen and determines whether it is a Bluetooth broadcast sent by the electronic pen corresponding to the Bluetooth MAC address.

When the display device determines that the Bluetooth broadcast is a Bluetooth broadcast sent by the electronic pen corresponding to the Bluetooth MAC address, step S415 is executed. When the display device determines that the Bluetooth broadcast is not a Bluetooth broadcast sent by the electronic pen corresponding to the Bluetooth MAC address, step S401 is executed.

Step S415: The display device establishes a Bluetooth connection with the electronic pen.

In embodiments of the present disclosure, when the electronic pen is operated between multiple display devices and the tablet paired with the electronic pen is saturated, the Bluetooth pairing list can be deleted when the electronic pen sends the Bluetooth MAC address to the new display device by the coding downlink signal, and rebroadcasting Bluetooth information. This can cause the display device to trigger a Bluetooth pairing/connection pop-up window to achieve accurate and convenient Bluetooth pairing connection.

Embodiments, embodiments of the present disclosure provide two connection devices. The device includes modules. Each module includes sub-modules, and each sub-module includes a unit, which can be implemented by a processor in an electronic device. Of course, it can also be implemented through specific logic circuits. During the implementation process, the processor can be a central processing unit (CPU), a microprocessor unit (MPU), a digital signal process (DSP), or a field programmable gate array (FPGA), etc.

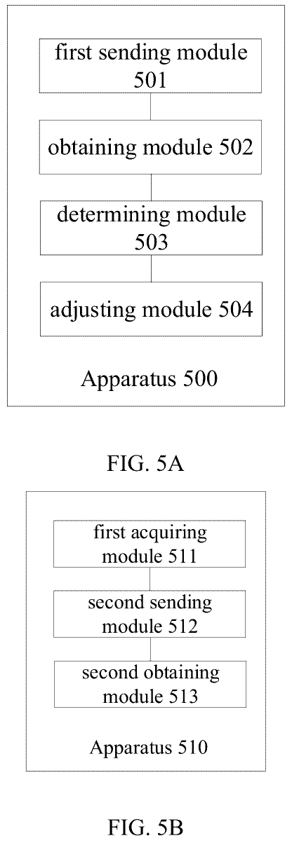

FIG. 5A is a schematic structural diagram of a connection device according to embodiments of the present disclosure. As shown in FIG. 5A, the device 500 includes:

A first sending module 501, configured to send a coding downlink signal to a second electronic device, where the coding downlink signal carries an identifier of a first communication module of a first electronic device;

An obtaining module 502, configured to obtain a request from the second electronic device to establish a first communication connection based on the identifier;

A determining module 503, configured to determine that a communication connection status of the first communication module of the first electronic device does not meet a preset condition;

An adjustment module, configured to adjust the communication connection status to establish a first communication connection with the second electronic device based on the first communication module.

In some embodiments, satisfying the preset condition includes: the quantity of second communication connections established by the first communication module and the third electronic device is less than a preset threshold.

In some embodiments, the determining module 503 includes a determining sub-module and an adjusting sub-module, where the determining sub-module is used to determine that the quantity of second communication connections established by the first communication module and the third electronic device is greater than or equal to the preset threshold; The adjustment sub-module is used to adjust the quantity of second communication connections between the first communication module and the third electronic device to meet the preset condition.

In some embodiments, the adjusting sub-module includes a first determining unit and a first deleting unit, where the first determining unit is used to determine the order of establishing a communication connection with the third electronic device. A deleting unit is for deleting the third electronic device that first establishes a communication connection in the communication connection list. Or the adjusting sub-module includes a second determining unit and a second deleting unit, where the second determining unit is used to determine the distance between each third electronic device and the first electronic device in the communication connection list. The second deleting unit is used to delete the farthest third electronic device in the communication connection list. Alternatively, the adjusting sub-module includes a third determining unit and a third deleting unit, where the third determining unit is used to determine the amount of communication data between each of the third electronic device and the first electronic device in the communication connection list. The third deleting unit is used to delete the third electronic device with the smallest amount of communication data in the communication connection list.

In some embodiments, the coding downlink signal includes partial data of the identifier in each frame.

In some embodiments, the obtaining module 502 is also configured to receive a coding uplink signal sent by the second electronic device based on the identifier. If the coding uplink signal includes a first command, it determines to obtain the coded uplink signal. The second electronic device establishes a request for a first communication connection based on the identifier.

FIG. 5B is a schematic structural diagram of a connection device according to embodiments of the present disclosure. As shown in FIG. 5B, the device 510 includes:

The first obtaining module 511 is used to obtain the coding downlink signal sent by the first electronic device, where the coding downlink signal carries the identifier of the first communication module of the first electronic device;

The second sending module 512 is configured to send a request to establish a first communication connection based on the identifier to the first electronic device;

The second obtaining module 513 is used to obtain the broadcast message sent by the first electronic device to establish a first communication connection with the first communication module of the first electronic device.

In some embodiments, the first obtaining module 511 is also used to obtain a multi-frame coding downlink signal sent by the first electronic device, where each frame of the coding downlink signal carries partial identifier data of the first electronic device of the first communication module, and obtain the identifier data of the first communication module based on the multi-frame identifier data.

The description of aforementioned device embodiments is similar to the description of aforementioned method embodiments, and has similar beneficial effects as aforementioned method embodiments. For technical details not disclosed in the device embodiments of the present disclosure, please refer to the description of aforementioned method embodiments of the present disclosure for understanding.

It should be noted that in embodiments of the present disclosure, if the above method is implemented in the form of a software function module and sold or used as an independent product, it can also be stored in a computer-readable storage medium. Based on this understanding, the technical solutions of the embodiments of the present disclosure can be implemented in the form of software products in essence or those that contribute to related technologies. The computer software product is stored in a storage medium and includes a quantity of instructions to cause the electronic device (such as mobile phone, tablet computer, notebook computer, desktop computer, etc.) to execute all or part of the methods described in various embodiments of the present disclosure. The storage media include: U disk, mobile hard disk, read only memory (ROM), magnetic disk, or optical disk and other various media that can store program codes. As such, embodiments of the present disclosure are not limited to any specific combination of hardware and software.

Correspondingly, embodiments of the present disclosure provide a storage medium on which a computer program is stored. When the computer program is executed by a processor, the steps in the connection method provided in the above embodiments are implemented.

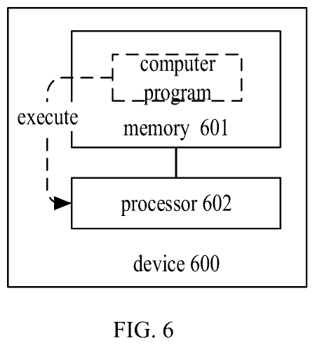

Correspondingly, embodiments of the present disclosure provide an electronic device. FIG. 6 is a schematic diagram of a hardware entity of the electronic device according to embodiments of the present disclosure. As shown in FIG. 6, the hardware entity of the device 600 includes: a memory 601 and a processing unit. The memory 601 stores a computer program that can be run on the processor 602. When the processor 602 executes the program, the steps in the connection method provided in the above embodiment are implemented.

The memory 601 is configured to store instructions and applications executable by the processor 602, and can also cache data to be processed or processed by the processor 602 and each module in the electronic device 600 (for example, image data, audio data, voice communication data, and Video communication data), which can be implemented through flash memory (FLASH) or random access memory (RAM).

It should be pointed out here that the above description of the storage medium and device embodiments is similar to the description of aforementioned method embodiments, and has similar beneficial effects as aforementioned method embodiments. For technical details not disclosed in the storage medium and device embodiments of the present disclosure, please refer to the description of aforementioned method embodiments of the present disclosure for understanding.

It will be understood that reference throughout this specification to “one embodiment” or “an embodiment” means that a particular feature, structure, or characteristic associated with the embodiment is included in at least one embodiment of the present disclosure. Thus, the appearances of “in one embodiment” or “in an embodiment” in various places throughout this specification are not necessarily referring to a same embodiment. Furthermore, the particular features, structures, or characteristics can be combined in any suitable manner in one or more embodiments. It should be understood that in the various embodiments of the present disclosure, the size of the sequence numbers of the above-mentioned processes does not mean the order of execution. The execution order of each process should be determined by its functions and internal logic, and should not be used in the embodiments of the present disclosure. The implementation process constitutes any limitation. The above serial numbers of the embodiments of the present disclosure are only for description and do not represent the advantages and disadvantages of the embodiments.

It should be noted that, in this document, the terms “comprising”, “comprises” or any other variation thereof are intended to cover a non-exclusive inclusion, such that a process, method, article or device that includes a series of elements not only includes those elements. It also includes other elements not expressly listed or inherent in the process, method, article or apparatus. Without further limitation, an element defined by the statement “comprises a . . . ” does not exclude the presence of additional identical elements in a process, method, article or apparatus that includes that element.

In various embodiments of the present disclosure, it should be understood that the disclosed devices and methods can be implemented in other ways. Device embodiments described above are only illustrative. For example, the division of the units is only a logical function division. In actual implementation, there can be other division methods, such as: multiple units or components may be combined, or can be integrated into another system, or some features can be ignored, or not implemented. In addition, the coupling, direct coupling, or communication connection between the components shown or discussed can be through some interfaces, and the indirect coupling or communication connection of the devices or units can be electrical, mechanical, or other forms.

The units described above as separate components may or may not be physically separated. The components shown as units may or may not be physical units. They may be located in one place or distributed to multiple network units. Some or all of the units can be selected according to actual needs to achieve the purpose of the solution of this embodiment.

In addition, all functional units in embodiments of the present disclosure can be integrated into one processing unit, or each unit can be separately used as a unit, or two or more units can be integrated into one unit. The above integrated unit can be implemented in the form of hardware or in the form of hardware plus software functional units.

Those persons of ordinary skill in the art can understand that all or part of the steps to implement above method embodiments can be completed through hardware related to program instructions. The aforementioned program can be stored in a computer-readable storage medium. When the program is executed, the execution includes: the steps of above method embodiments. The aforementioned storage media include: mobile storage devices, read-only memory (ROM), magnetic disks or optical disks and other various media that can store program codes.

Alternatively, if the integrated units mentioned above in this application are implemented in the form of software function modules and sold or used as independent products, they can also be stored in a computer-readable storage medium. Based on this understanding, the technical solutions of embodiments of the present disclosure can be implemented in the form of software products in essence or those that contribute to related technologies. The computer software product is stored in a storage medium and includes a quantity of instructions to cause the electronic device (which may be a mobile phone, tablet computer, notebook computer, desktop computer, etc.) to execute all or part of the methods described in various embodiments of this application. The aforementioned storage media include: mobile storage devices, ROMs, magnetic disks or optical disks and other media that can store program codes.

The methods disclosed in several method embodiments provided in the present disclosure can be combined arbitrarily to obtain new method embodiments without conflict.

The features disclosed in several product embodiments provided in the present disclosure can be combined arbitrarily without conflict to obtain new product embodiments.

The features disclosed in several method or device embodiments provided in the present disclosure can be combined arbitrarily without conflict to obtain new method embodiments or device embodiments.

The above are only embodiments of the present disclosure, but the protection scope of the present disclosure is not limited thereto. Any person familiar with the technical field can easily think of changes or substitutions within the technical scope disclosed in this application, and they should be covered by the protection scope of this application. Therefore, the protection scope of this application should be subject to the protection scope of the claims.

What is claimed is:

1. A connection method, applied to a first electronic device, comprising
sending a coding downlink signal to a second electronic device, wherein the coding downlink signal carries an identifier of a first communication module of the first electronic device;
obtaining a request from the second electronic device to establish a first communication connection based on the identifier;
determining that a communication connection status of the first communication module of the first electronic device does not meet a preset condition; and
adjusting the communication connection status to establish the first communication connection with the second electronic device based on the first communication module.

2. The connection method according to claim 1, wherein the present condition comprises a quantity of second communication connections established by the first communication module with a third electronic device being less than a preset threshold.

3. The connection method according to claim 1, wherein determining that the communication connection status of the first communication module of the first electronic device does not meet the preset condition comprises:
determining that a quantity of second communication connections established by the first communication module with a third electronic device being greater than or equal to a preset threshold; and
adjusting the quantity of second communication connections between the first communication module and the third electronic device to meet the preset condition.

4. The connection method according to claim 3, wherein adjusting the quantity of the second communication connections to meet the preset condition comprises:
determining an order in which a communication connection is established with the third electronic device; and deleting an earliest third electronic device that establishes the communication connection from a communication connection list; or
determining a distance between each of the third electronic device and the first electronic device in the communication connection list; and deleting a farthest third electronic device from the communication connection list; or
determining an amount of communication data between each of the third electronic device and the first electronic device in the communication connection list; and deleting the third electronic device with the smallest amount of communication data from the communication connection list.

5. The connection method according to claim 1, wherein the coding downlink signal in each frame comprises partial data of the identifier.

6. The connection method according to claim 1, wherein obtaining the request from the second electronic device to establish the first communication connection based on the identifier comprises:
receiving a coding uplink signal sent by the second electronic device based on the identifier; and in the event the coding uplink signal comprises a first command, confirming obtaining the request from the second electronic device to establish a first communication connection based on the identifier.

7. A connection method, applied to a second electronic device, comprising:
obtaining a coding downlink signal sent by a first electronic device, wherein the coding downlink signal carries an identifier of a first communication module of the first electronic device;
sending a request to establish a first communication connection based on the identifier to the first electronic device; and
obtaining a broadcast message sent by the first electronic device to establish the first communication connection with the first communication module of the first electronic device.

8. The connection method according to claim 7, wherein obtaining the coding downlink signal sent by the first electronic device comprises:
obtaining a multi-frame coding downlink signal sent by the first electronic device, wherein
each frame of the multi-frame coding downlink signal carries a partial identifier data of the first communication module of the first electronic device; and
based on a multi-frame of the partial identifier data, the identifier data of the first communication module is obtained.

9. An electronic device system, comprising:
a first electronic device, comprising at least one processor and a memory containing program instructions that, when being executed, cause the at least one processor to:
send a coding downlink signal to a second electronic device, wherein the coding downlink signal carries an identifier of a first communication module of the first electronic device;
obtain a request from the second electronic device to establish a first communication connection based on the identifier;
determine that a communication connection status of the first communication module of the first electronic device does not meet a preset condition; and
adjust the communication connection status to establish the first communication connection with the second electronic device based on the first communication module; and
at least one third electronic device, configured to establish a second communication connection with the first communication module.

10. The system according to claim 9, wherein the second electronic device comprising at least one processor and a memory containing program instructions that, when being executed, cause the at least one processor to:
obtain the coding downlink signal sent by the first electronic device, wherein the coding downlink signal carries the identifier of the first communication module of the first electronic device;
send a request to establish the first communication connection based on the identifier to the first electronic device; and
obtain a broadcast message sent by the first electronic device to establish the first communication connection with the first communication module of the first electronic device.

11. The system according to claim 9, wherein the present condition comprises a quantity of second communication connections established by the first communication module with a third electronic device being less than a preset threshold.

12. The system according to claim 9, wherein the at least one processor of the first electronic device is further configured to:
determine that a quantity of second communication connections established by the first communication module with a third electronic device being greater than or equal to a preset threshold; and
adjust the quantity of second communication connections between the first communication module and the third electronic device to meet the preset condition.

13. The system according to claim 12, wherein the at least one processor of the first electronic device is further configured to:
determine an order in which a communication connection is established with the third electronic device; and deleting an earliest third electronic device that establishes the communication connection from a communication connection list; or
determine a distance between each of the third electronic device and the first electronic device in the communication connection list; and deleting a farthest third electronic device from the communication connection list; or
determine an amount of communication data between each of the third electronic device and the first electronic device in the communication connection list; and deleting the third electronic device with the smallest amount of communication data from the communication connection list.

14. The system according to claim 9, wherein the coding downlink signal in each frame comprises partial data of the identifier.

15. The system according to claim 9, wherein the at least one processor of the first electronic device is further configured to:
receive a coding uplink signal sent by the second electronic device based on the identifier; and in the event the coding uplink signal comprises a first command, confirming obtaining the request from the second electronic device to establish a first communication connection based on the identifier.

16. The system according to claim 10, wherein the at least one processor of the second electronic device is further configured to:
obtain a multi-frame coding downlink signal sent by the first electronic device, wherein
each frame of the multi-frame coding downlink signal carries a partial identifier data of the first communication module of the first electronic device; and
based on a multi-frame of the partial identifier data, the identifier data of the first communication module is obtained.
